(19) United States
(12) Patent Application Publication
(10) Pub. No.: US 2020/0060292 A1
(43) Pub. Date: Feb. 27, 2020

(54) PIZZA SPINNER

(71) Applicant: LTECH L.L.C., Enfield, NH (US)

(72) Inventor: John F. Lewis, Enfield, NH (US)

(73) Assignee: LTECH L.L.C., Enfield, NH (US)

(21) Appl. No.: 16/547,666

(22) Filed: Aug. 22, 2019

Related U.S. Application Data
(60) Provisional application No. 62/721,893, filed on Aug. 23, 2018.

(51) Int. Cl. A21C 11/00; A21C 3/02; A21D 13/41

(52) U.S. Cl. CPC A21C 11/008; A21D 13/41; A21C 3/02

(57) ABSTRACT

A device, system, and method for pizza dough shaping having a main housing 205; main drive 210; turntable 215 that holds the pan for rotation; clamping system 220 positioning the pan concentrically on the turntable 215 and holding it securely during spinning; forming ring 225 working with ram 230; and ram drive 235; wherein the device operation includes placing a dough ball roughly centered on the pan 1305; placing the pan onto turntable 1310; initiating start 1315; clamps engaging and centering pan on turntable 1320; forming ring lowering and surrounding dough ball 1325; ram lowering and pressing dough ball into a pancake that is accurately round and of uniform thickness 1330; readying to spin 1335; spinning ramp-up 1340; sustaining 1345; and ramping down 1350 through preselected profiles for uniform results, whereby the dough ball is formed into a finished pizza crust disk in approximately 30 seconds.

### RELATED APPLICATIONS

This application claims the benefit of U.S. Provisional Application No. 62/721,893, filed Aug. 23, 2018. This application is herein incorporated by reference in its entirety for all purposes.

### FIELD

The invention relates to pizza dough shaping, and, more particularly, to a device, system, and method to automatically produce consistent, quality, pizza dough results.

### BACKGROUND

There are 75,000 pizzerias in the US alone. Most prepare crusts by hand, with little or no automation. Pizza making enterprises include large chain restaurants (3000+ locations), large supermarkets with bakery/deli/pizza service, and smaller restaurants and markets. Currently, pizza making efforts are weak and do not address the following requirements. Dough can be spun perfectly only if the following are satisfied: 1) dough pancake must be perfectly round; 2) dough pancake must be perfectly uniform; 3) dough pancake must be perfectly centered in pan; 4) pan must be perfectly centered on spinning surface; and 5) spinning must be uniform.

The use of centrifugal force has, for a long time, been the standard for preparing quality pizza dough. The traditional spinning method requires a high level of skill that is not easily duplicated. Large scale production of pizzas and flatbreads use large, complex and expensive machines that are beyond the reach of small restaurants. Most restaurants still use slow and inconsistent hand methods to prepare pizzas. This is labor intensive and often inconsistent.

The idea of spinning pizza dough in the pan is not unique. Others have tried it but failed to make it reliable or consistent. Results were dependent on skill of dough preparation, pancake preparation, placement and the timing and observation of the spinning process. Also, these devices were difficult to operate and potentially dangerous.

What is needed is a machine that can duplicate the quality results of skilled pizza spinning, in a shorter time with economics that make it available to large and small restaurants and home users. Spinning the dough in the pan by the disclosed embodiment method gives the desired results. This provides restaurants and homes with more economic, higher quality, more easily reproduced product and more consistent results. Goals to meet, especially for restaurant equipment, comprise increasing profits by speed, labor reduction and improved quality. Speed must be high. Cost must be reasonable. Skill must be removed from the process as much as possible. Safety must be foolproof. To accomplish these goals, embodiments have the following elements: must be easy to use; skill must be eliminated as much as possible; must be fast and consistent; must be adaptable to varying recipes and styles, crust thickness, etc.; must be durable to survive the commercial environment; and return on investment must be short.

### Glossary

DOUGH BALL refers to prepared dough of correct size and weight that has not been shaped into the desired form.

DOUGH PANCAKE refers to prepared and divided dough preformed into a consistent disk shape ready for forming or spinning. The pancake can be, but is not restricted to a disk, a concave disk, a convex disk, or any user desired preformed shape prepared for spinning.

PIZZA DOUGH, PREPARED DOUGH, PIZZA CRUST and FLATBREAD all refer to the prepared dough that can be cooked directly or cooked after adding other ingredients such as sauces, meats vegetables, cheese, etc. Pizza dough usually refers to, but is not restricted to, a blend of flour, water or other liquids, and yeast that has been prepared and allowed to rise in preparation for the making of the pizza.

SPINNING refers to the use of centrifugal force to shape a pizza from a ball or pancake into a final shape ready for cooking.

### SUMMARY

An embodiment provides a device for pizza dough shaping comprising a main housing 205; a main drive 210; a turntable 215 holding a pan for rotation; a clamping system 220 positioning the pan concentrically on the turntable 215 and holding the pan securely during spinning; a forming ring 225 working with a ram 230; and a ram drive 235. In embodiments a gripping system comprises a plurality of grippers 1005; a plurality of gripper arms 1010; a plurality of counterweights 1015; a plurality of synchronizing linkages 1020; and a rotor 1025. In other embodiments a gripping system comprises three grippers 1005; three gripper arms 1010; three counterweights 1015; three synchronizing linkages 1020; and a rotor 1025. Subsequent embodiments comprise a plurality of grippers 1005; a plurality of gripper arms 1010; a plurality of counterweights 1015; and a plurality of synchronizing linkages 1020; and a rotor 1025; wherein each of the gripper arms comprises a first pivot proximate a first end, a the gripper proximate a second end of the gripper arm, and a first end of a the synchronizing linkage pivotally affixed to the gripper arm between the first pivot and the gripper. For additional embodiments a corresponding the counterweight is pivotally affixed proximate a second end of the synchronizing linkage opposite the first end of the synchronizing linkage. In another embodiment each of the counterweights comprises a counterweight pivot proximate a first end of the counterweight, whereby each of the counterweights is pivotally attached to the rotor. For a following embodiment a gripping system comprises three grippers 1005; three gripper arms 1010; three counterweights 1015; three synchronizing linkages 1020; and a rotor 1025; wherein each of the synchronizing linkages comprises a first end pivotally affixed to the counterweight, and a second end pivotally attached to a corresponding gripper arm; whereby a centrifugal force is transmitted to each corresponding gripper arm, whereby a gripper grips the pan. In subsequent embodiments the rotor 1025 is pivotally attached to an end of each gripper arm 1010 and each of the counterweights 1015. In additional embodiments the counterweight pivot and the corresponding gripper arm pivot are co-aligned. In ensuing embodiments the counterweights 1015 extend opposite pivot point 1105 from the gripper arms 1010. In included embodiments a mass of each of the counterweights 1015 multiplied by a distance 1110 from the pivot point to a center of mass of the counterweight 1015 is greater than a mass of the gripper arm 1010 and the gripper 1005 multiplied by a distance from the pivot point to the center of its mass. In yet further embodiments an outward rotation of the counterweights results in an inward rotation of the grippers. In related embodiments a weight of each of a plurality of counterweights is between about 5 pounds to about 12 pounds. For further embodiments a weight of each of a plurality of counterweights is about 8 pounds.

Another embodiment provides a method for pizza dough shaping comprising placing a dough ball roughly centered on a pan 1305; placing the pan onto a turntable 1310; initiating a start 1315; engaging and centering gripping clamps of a clamping system 220 on the pan on the turntable 1320; lowering a forming ring, surrounding the dough ball 1325; lowering the ram, pressing the dough ball into a pancake that is accurately round and of uniform thickness 1330; readying to spin 1335; spinning ramp-up 1340; sustaining spin 1345; and ramping down 1350 through preselected profiles for uniform results, whereby the dough ball is formed into a finished pizza crust disk in approximately 30 seconds. For yet further embodiments, the step of engaging and centering 1320 comprises an inward force of the gripping clamps against the pan, the inward force comprising a spring force. For more embodiments, the step of spinning ramp-up 1340 comprises an inward-rotation of counterweights, whereby the gripping clamps are forced against the pan, aligning the pan concentrically to a rotation axis of the pan. In continued embodiments the step of ramping down 1350 comprises an outward-rotation of counterweights, whereby a force of the gripping clamps against the pan is decreased. For additional embodiments, as the rotor 1025 rotates faster, a grip on pan 1030 increases in proportion to a rotation speed; and a gripping force on the pan 1030 is an initial spring force plus a centrifugal effect force.

A yet further embodiment provides a system for pizza dough shaping comprising a main housing 205; a main drive 210; a turntable 215 holding a pan for rotation; a clamping system 220 positioning the pan concentrically on turntable 215 and holding it securely during spinning; a forming ring 225 working with a ram 230; and a ram drive 235; wherein the device operation steps comprise placing a dough ball roughly centered on the pan 1305; placing the pan onto the turntable 1310; initiating start 1315; clamps of the clamping system 220 engaging and centering the pan on the turntable 1320; the forming ring lowering and surrounding the dough ball 1325; the ram lowering and pressing the dough ball into a pancake that is substantially round and of uniform thickness 1330; readying to spin 1335; spinning ramp-up 1340; sustaining spinning at between about 200 and about 300 rpm 1345; and ramping down 1350 through preselected profiles for uniform results, whereby the dough ball is formed into a finished pizza crust disk in approximately 30 seconds.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 depicts scenarios and benefits configured in accordance with one embodiment of the present invention.

FIG. 2 is a perspective view configured in accordance with one embodiment of the present invention.

FIG. 3 is a plan view configured in accordance with one embodiment of the present invention.

FIG. 4 is a cross-section view configured in accordance with one embodiment of the present invention.

FIG. 5 is a perspective view of the dough centered in pan step configured in accordance with one embodiment of the present invention.

FIG. 6 is a perspective view of the forming ring lowering and surrounding dough ball step configured in accordance with one embodiment of the present invention.

FIG. 7 is a perspective view of the ram lowering and gently pressing dough ball into pancake step configured in accordance with one embodiment of the present invention.

FIG. 8 is a perspective view of the ready to spin step configured in accordance with one embodiment of the present invention.

FIG. 9 is a perspective view following spin profile steps configured in accordance with one embodiment of the present invention.

FIG. 10 is a plan view of a turntable gripping system in an open position configured in accordance with one embodiment of the present invention.

FIG. 11 is a plan view of a turntable gripping system in a closed position configured in accordance with one embodiment of the present invention.

FIG. 12 is a graph depicting a rotation speed profile configured in accordance with one embodiment of the present invention.

FIG. 13 is a flow chart illustrating a method configured in accordance with one embodiment of the present invention.

### DETAILED DESCRIPTION

Embodiments of the device disclosed can take a dough ball and a pan and create all of the below conditions to achieve the desired results. A dough pancake accurately round; the dough pancake accurately uniform; the pancake can be concave, convex or any desired shape that is radially uniform; the dough pancake must be accurately centered in pan; the pan must be perfectly centered on spinning surface; the spinning of the pan must be uniform. In embodiments the pan diameter is 8″ for a personal size, 10″ for a small size, 12″ for a medium size, 14″ for a large size, and 16″ for an extra-large size.

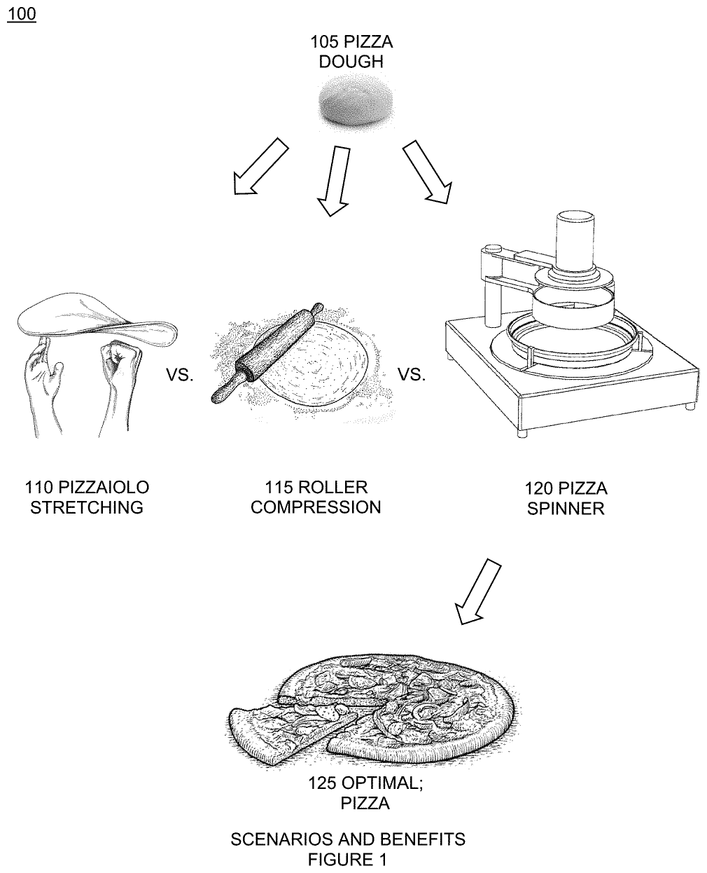

FIG. 1 depicts scenarios and benefits 100. Pizza preparation beginning with dough 105 can be accomplished via multiple methods. The traditional and most favored method is by a skilled pizzaiolo (pizza twirler) 110 who opens (stretches) the pizza dough 105 to form the disk of pizza dough to receive toppings and be baked. While this may produce the best results, skilled pizzaiolos are not readily available for a great number of the restaurants and shops mentioned above, let alone households. An inferior option is rolling the dough 115 to squash dough 105 into a disk. By its nature, this condenses the dough, squeezing the entrained air from the dough, resulting in a tough, undesirable, final pizza. In contrast, pizza spinner 120 accomplishes the results of a professional pizzaiolo by applying similar forces to the dough 105 with gentle kneading-quality compression and centrifugal force stretching to produce a reliable, quality, optimal pizza 125. Quality includes tenderness due to quick stretching, no tearing, no weak spots, correct, uniform, thickness, and uniform air bubble entrainment—not too many/large air bubbles for baking.

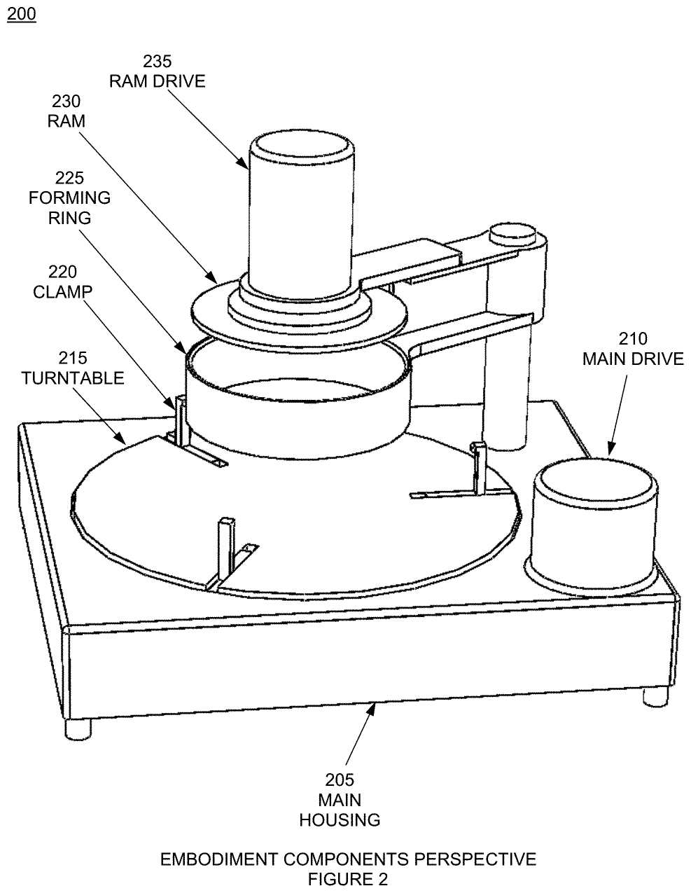

FIG. 2 is a device perspective view 200. Device embodiment components comprise: main housing 205; main drive 210; turntable 215 that will hold the pan for rotation; clamping system 220 that will position the pan concentrically on turntable 215 and hold it securely during spinning; forming ring 225 that will work with ram 230 and ram drive 235 to shape the ball into a pancake and center it on the pan; ram 230 works with forming ring 225 to form the ball into a uniform thickness pancake of the desired shape; drive systems that control: the ring placement, the ram placement and force, the clamping mechanism and the spinning; and a control system to make all of the elements work together with precision. In nonlimiting embodiments the drive comprises mechanical drives from a fixed speed motor using clutches and brakes; a stepper motor drive system capable of a precise speed profile; a motor drive system with appropriate controls for acceleration and velocity control; and a computer controlled servo drive system capable of a precise speed profile.

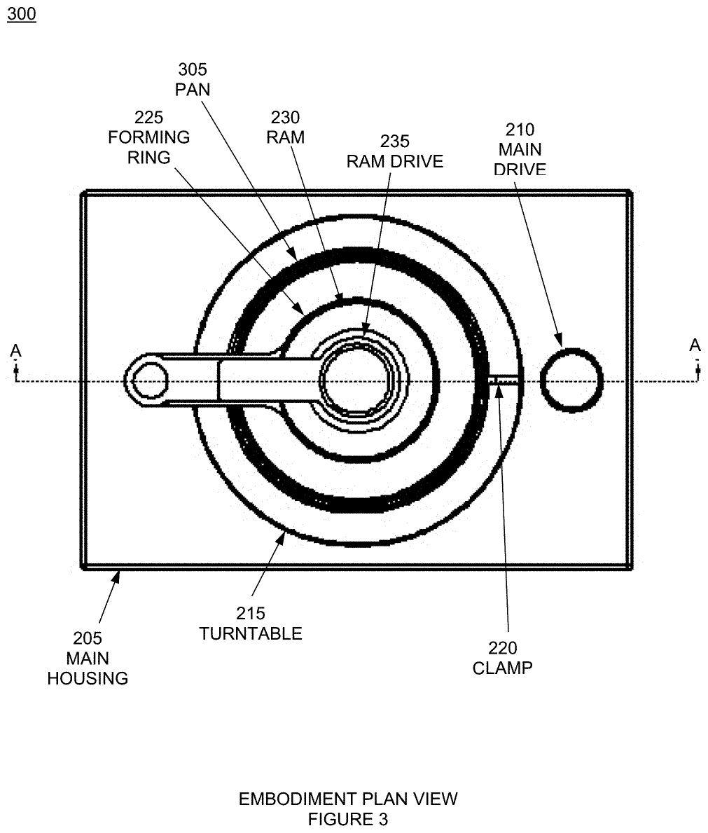

FIG. 3 is a plan view 300. As depicted in the perspective view of FIG. 2, plan view 300 shows device embodiment components main housing 205; main drive 210; turntable 215 that will hold the pan 305 for rotation; clamping system 220 that will position pan 305 concentrically on turntable 215 and hold it securely during spinning; forming ring 225 that will work with ram 230 and ram drive 235.

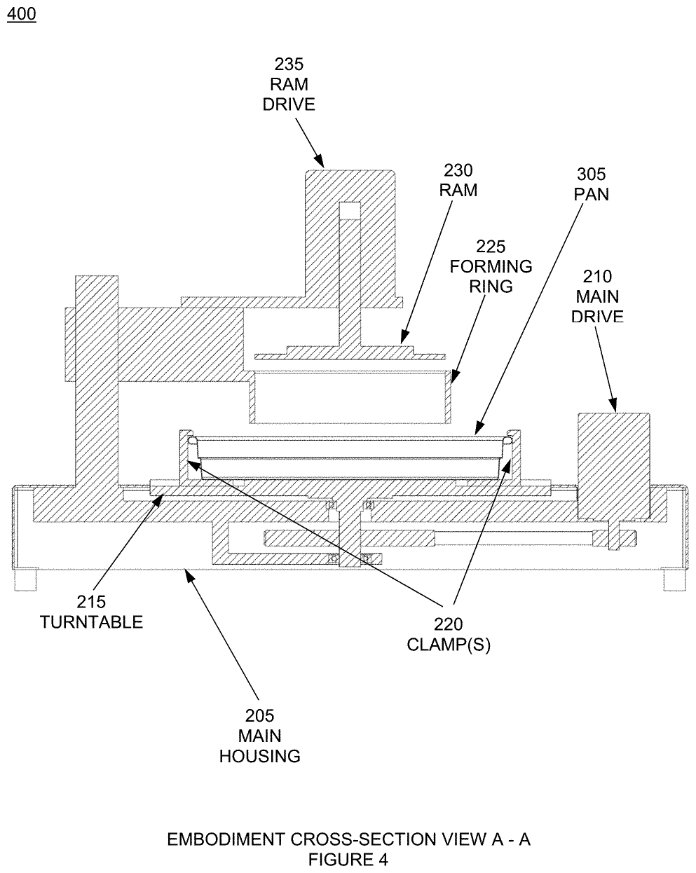

FIG. 4 is a cross-section view 400. The view is of section A—A from the plan view of FIG. 3. Again, as depicted in the views of FIGS. 2 and 3, cross-section view 400 shows device embodiment components main housing 205; main drive 210; turntable 215 that holds pan 305 for rotation; clamping system 220 that positions pan 305 concentrically on turntable 215 and holds it securely during spinning; forming ring 225 that works with ram 230 and ram drive 235.

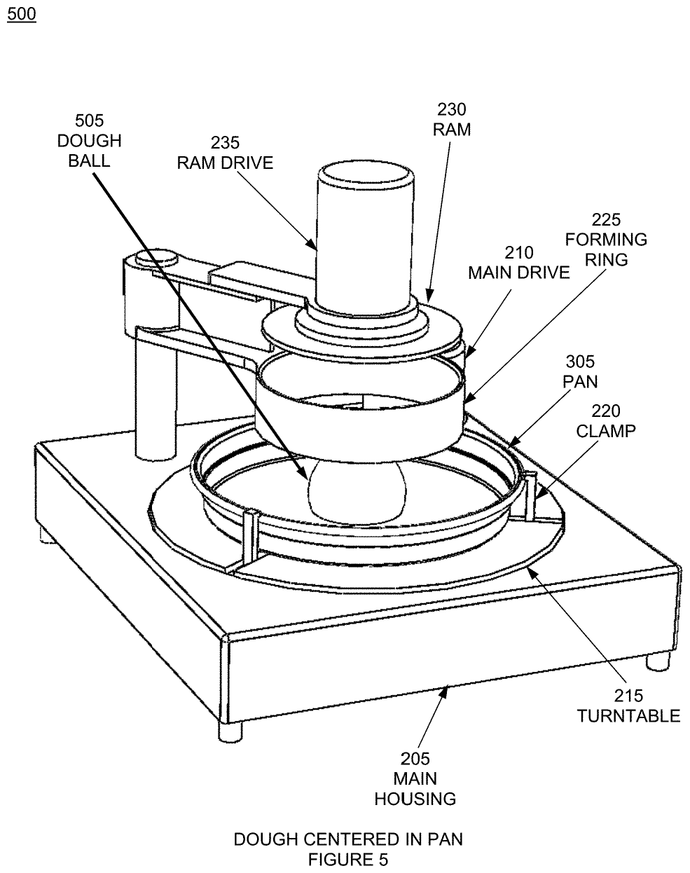

FIG. 5 is a perspective view of the dough centered in pan step 500. Depicted are dough ball 505 and components shown in FIG. 3 which comprise main housing 205; main drive 210; turntable 215 holding pan 305 for rotation; clamping system 220 positioning pan 305 concentrically on turntable 215 and holding it securely during spinning; forming ring 225 working with ram 230 and ram drive 235.

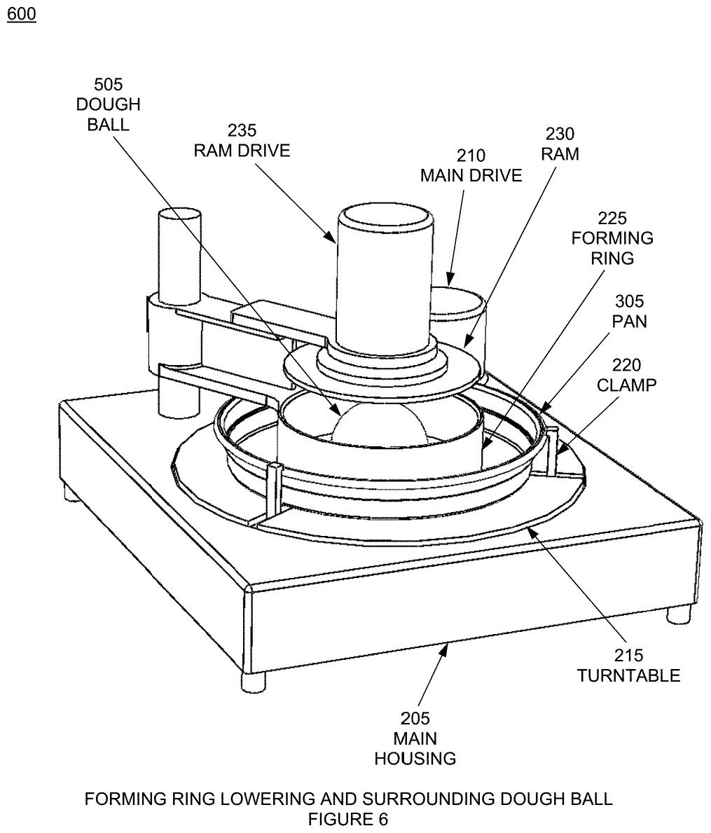

FIG. 6 is a perspective view of the forming ring lowering and surrounding dough ball step 600. Again, depicted are dough ball 505 and components shown in FIG. 3 which comprise main housing 205; main drive 210; turntable 215 holding pan 305 for rotation; clamping system 220 positioning pan 305 concentrically on turntable 215 and holding it securely during spinning; forming ring 225 working with ram 230 and ram drive 235.

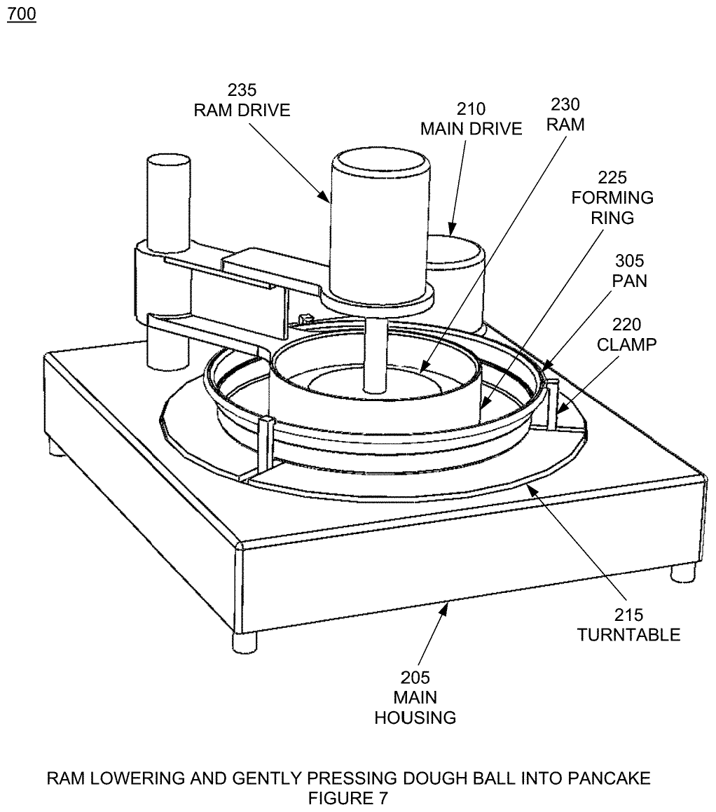

FIG. 7 is a perspective view of the ram lowering and gently pressing dough ball into pancake step 700. Here, depicted are components shown in FIG. 3 which comprise main housing 205; main drive 210; turntable 215 holding pan 305 for rotation; clamping system 220 positioning pan 305 concentrically on turntable 215 and holding it securely during spinning; forming ring 225 working with ram 230 and ram drive 235.

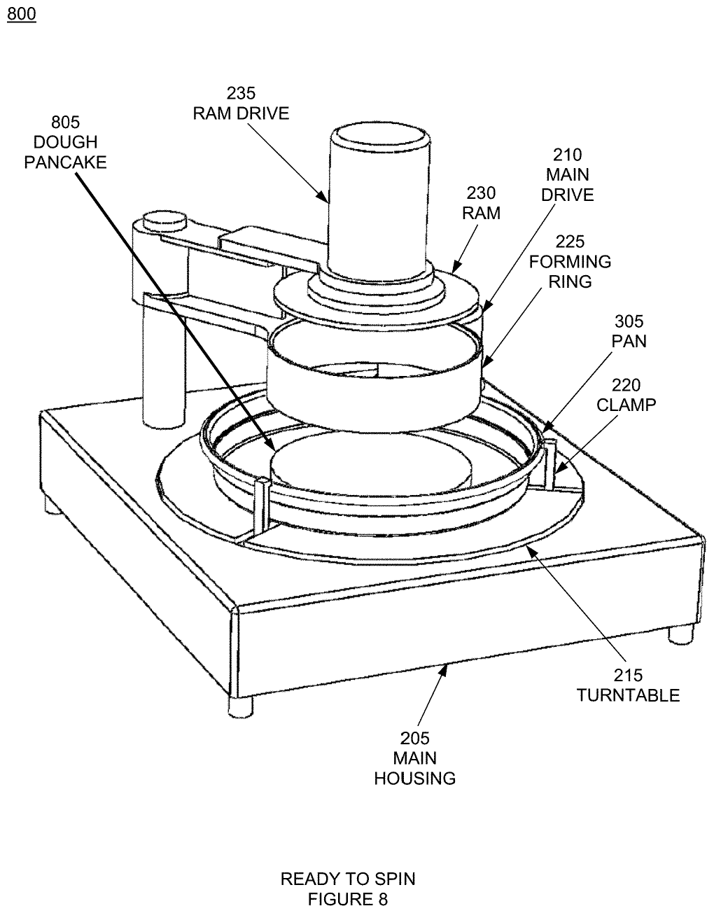

FIG. 8 is a perspective view of the ready to spin step 800. After the ram presses the dough into a pancake, it retracts along with the forming ring before spinning starts. Depicted are dough pancake 805 and components shown in FIG. 3 which comprise main housing 205; main drive 210; turntable 215 holding pan 305 for rotation; clamping system 220 positioning pan 305 concentrically on turntable 215 and holding it securely during spinning; forming ring 225 working with ram 230 and ram drive 235.

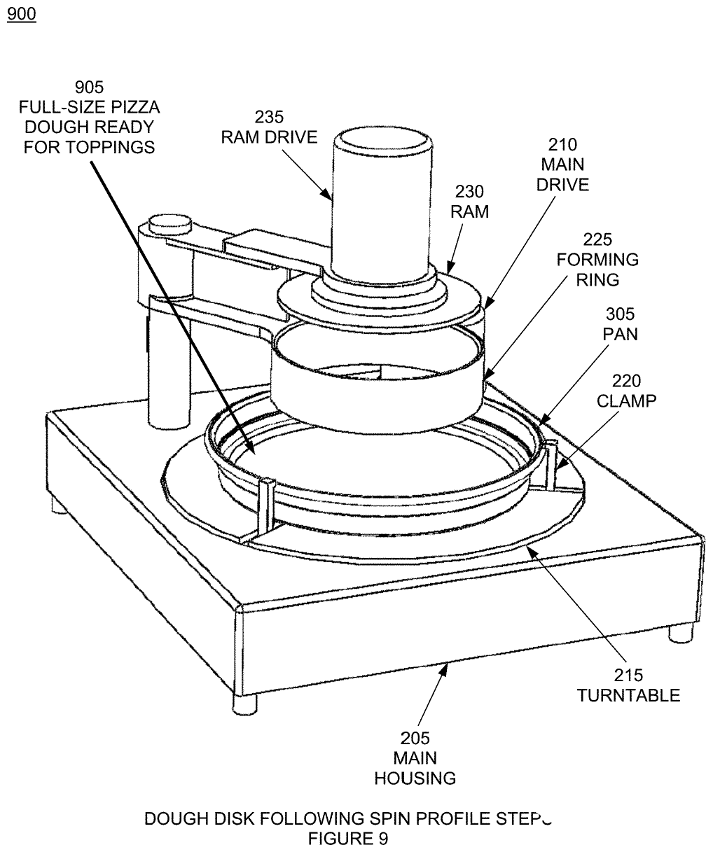

FIG. 9 is a perspective view following spin profile steps 900 depicting full-size pizza dough ready for toppings 905. Depicted are full-size pizza dough ready for toppings 905 and components shown in FIG. 3 which comprise main housing 205; main drive 210; turntable 215 holding pan 305 for rotation; clamping system 220 positioning pan 305 concentrically on turntable 215 and holding it securely during spinning; forming ring 225 working with ram 230 and ram drive 235.

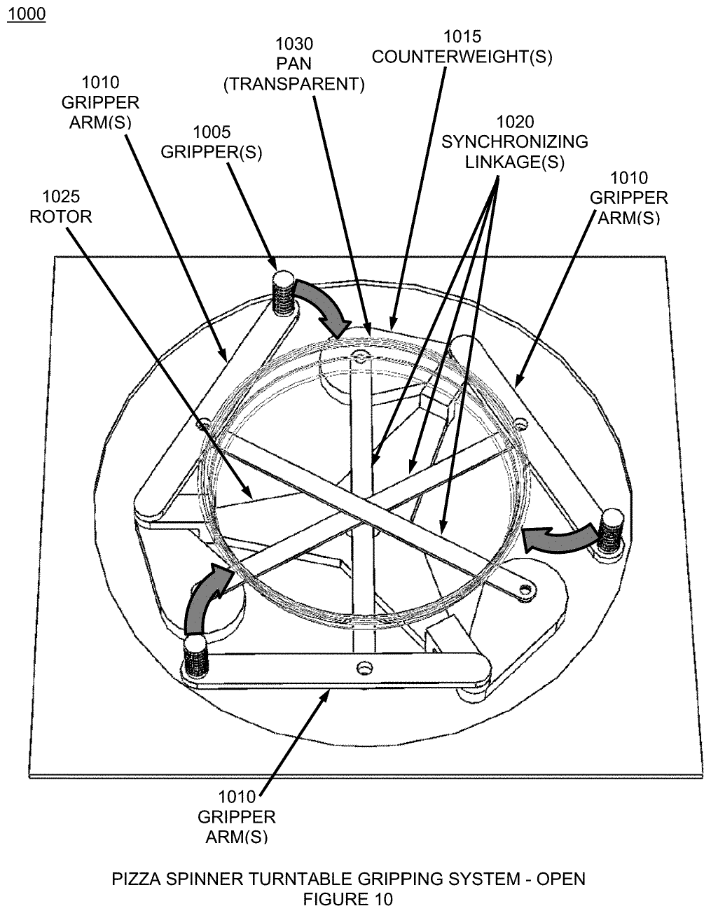

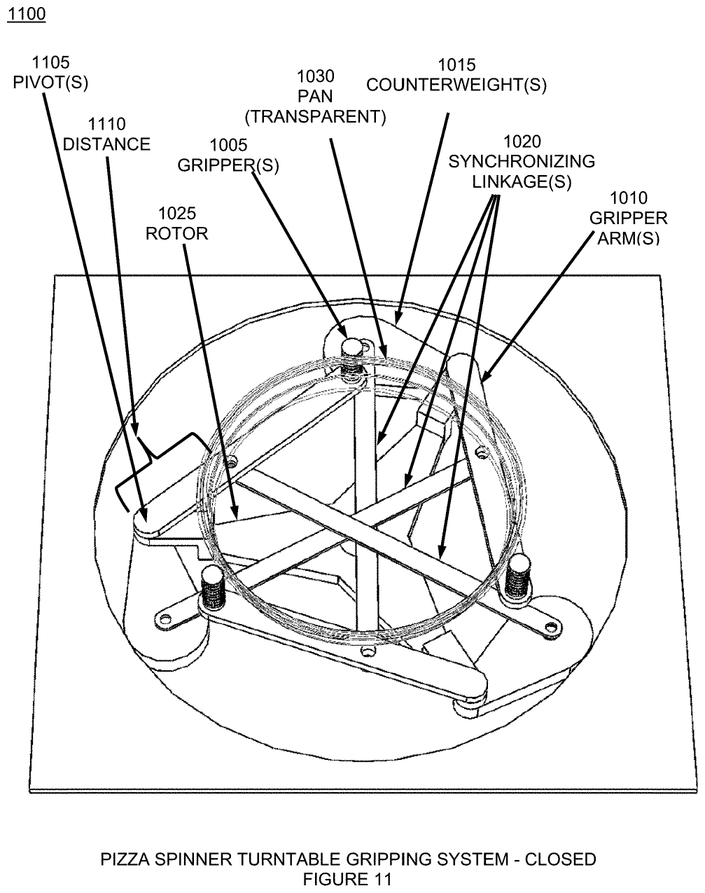

FIG. 10 is a plan view of a turntable gripping system embodiment in an open position 1000. In embodiments, clamping system 220 comprises gripping system depicted in FIGS. 10 and 11. Gripping system embodiment components comprise three grippers 1005; three gripper arms 1010; three counterweights 1015; three synchronizing linkages 1020; and rotor 1025; pan 1030 is shown as transparent. The synchronizing linkages 1020 connect the gripper arms 1010 together such that concentricity is maintained. No arm 1010 can be at a different distance from the center of rotation. In embodiments, the grippers 1005 are in contact with the pan 1030 edges under light spring force (springs not shown). For embodiments, springs are torsion springs rotating about the rotor-gripper arm pivot.

FIG. 11 is a plan view of a turntable gripping system embodiment in a closed position 1100. Gripping system embodiment components comprise those depicted in FIG. 10. As rotor 1025 rotates, counterweights 1015 expand outward through centrifugal force causing the gripper arms 1010 and grippers 1005 to move inward while the springs also draw the arms 1010 and grippers 1005 inward. The gripping force is the sum of the centrifugal effect and the springs. In embodiments, counterweights 1015 are mounted opposite the pivot point 1105. The mass of counterweight 1015 multiplied by distance 1110 from the pivot point to the center of mass of counterweight 1015 is greater than the mass of arm 1010 and gripper 1005 multiplied by the distance from the pivot point to the center of its mass. As rotor 1025 rotates faster, the grip on pan 1030 increases in proportion to the speed. Gripping force on pan 1030 is initial spring force+centrifugal effect.

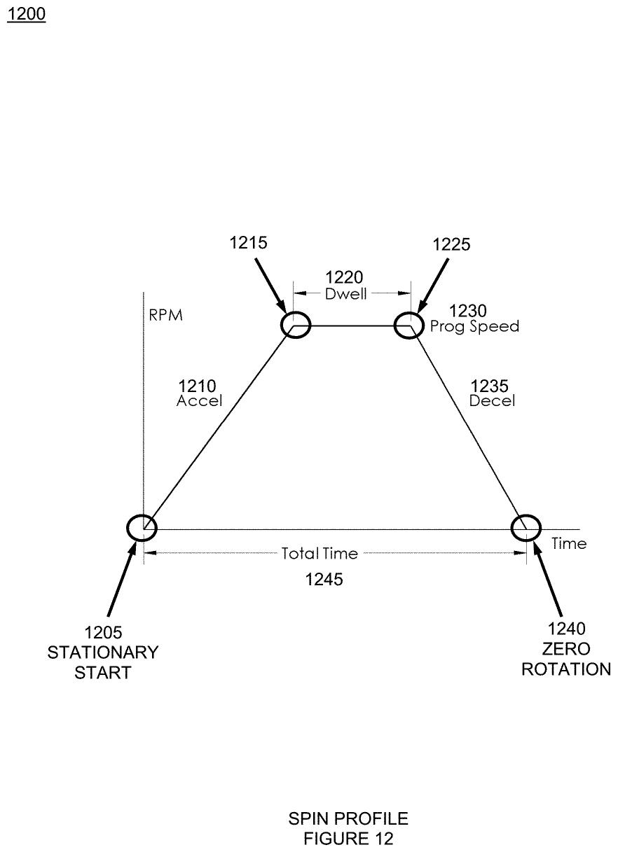

FIG. 12 is a graph depicting a rotation speed profile 1200. Spinning drive requirements comprise that the spinning of the pan and dough will be accomplished with precision for consistent results. Starting from stationary 1205, the pan will accelerate 1210 from 0 to a desired speed 1215, usually 200 to 300 revolutions per minute (RPM) in a precise time profile. Then the speed will be maintained for a specified dwell time 1220 (time can be 0). Then 1225, the speed will be returned, decelerating 1230 to 0 1235, in a precise time profile over a total time 1245.

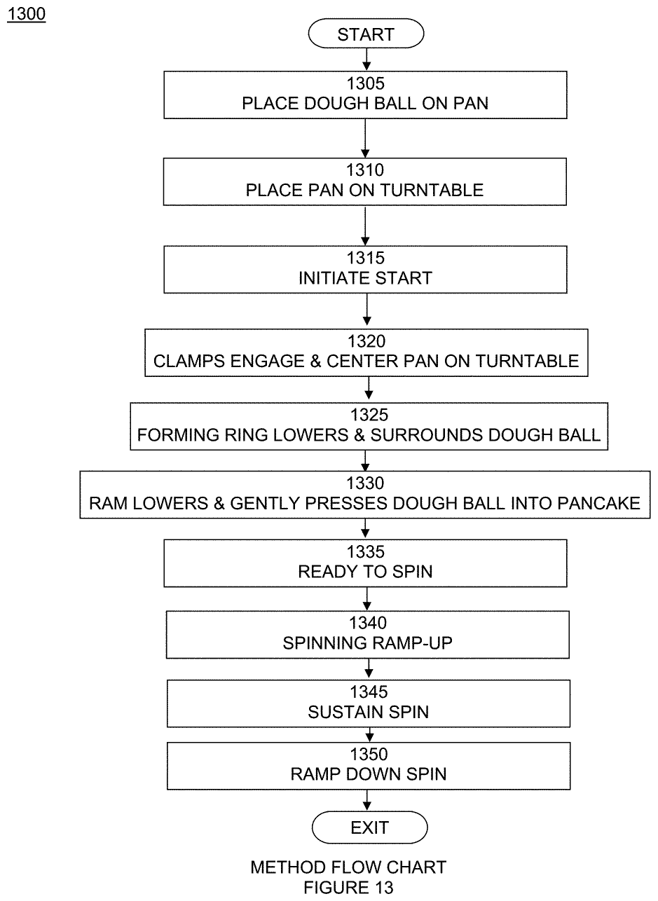

FIG. 13 is a flow chart 1300 of a method for making a disk for a pizza. Steps comprise placing a dough ball roughly centered on pan 1305; and place pan onto turntable 1310; initiate start 1315; clamps engage and center pan on turntable 1320; forming ring lowers and surrounds dough ball 1325; ram lowers and presses dough ball into pancake that is perfectly round and of uniform thickness 1330; ready to spin 1335 (after the ram presses the dough into a pancake, it retracts along with the forming ring before spinning starts); spinning ramp-up 1340; spinning sustained 1345; and spinning ramp down 1350 through preselected profiles for uniform results. Dough ball to finished pizza crust time is approximately 30 seconds.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device for pizza dough shaping comprising:
a main housing (205);
a main drive (210);
a turntable (215) holding a pan for rotation;
a clamping system (220) positioning said pan concentrically on said turntable (215) and holding said pan securely during spinning;
a forming ring (225) working with a ram (230); and
a ram drive (235).

2. The pizza dough shaping device of claim 1, wherein a gripping system comprises:
a plurality of grippers (1005);
a plurality of gripper arms (1010);
a plurality of counterweights (1015);
a plurality of synchronizing linkages (1020); and
a rotor (1025).

3. The pizza dough shaping device of claim 1, wherein a gripping system comprises:
three grippers (1005);
three gripper arms (1010);
three counterweights (1015);
three synchronizing linkages (1020); and
a rotor (1025).

4. The pizza dough shaping device of claim 1 comprising:
a plurality of grippers (1005);
a plurality of gripper arms (1010);
a plurality of counterweights (1015); and
a plurality of synchronizing linkages (1020); and
a rotor (1025);
wherein each of said gripper arms comprises a first pivot proximate a first end, a said gripper proximate a second end of said gripper arm, and a first end of a said synchronizing linkage pivotally affixed to said gripper arm between said first pivot and said gripper.

5. The pizza dough shaping device of claim 4, wherein a corresponding said counterweight is pivotally affixed proximate a second end of said synchronizing linkage opposite said first end of said synchronizing linkage.

6. The pizza dough shaping device of claim 4, wherein each of said counterweights comprises:
a counterweight pivot proximate a first end of said counterweight, whereby each of said counterweights is pivotally attached to said rotor.

7. The pizza dough shaping device of claim 4, wherein a gripping system comprises:
three grippers (1005);
three gripper arms (1010);
three counterweights (1015);
three synchronizing linkages (1020); and
a rotor (1025);
wherein each of said synchronizing linkages comprises a first end pivotally affixed to said counterweight, and a second end pivotally attached to a corresponding gripper arm;
whereby a centrifugal force is transmitted to each corresponding gripper arm, whereby a gripper grips said pan.

8. The pizza dough shaping device of claim 3, wherein said rotor (1025) is pivotally attached to an end of each gripper arm (1010) and each of said counterweights (1015).

9. The pizza dough shaping device of claim 8, wherein said counterweight pivot and said corresponding gripper arm pivot are co-aligned.

10. The pizza dough shaping device of claim 2, wherein said counterweights (1015) extend opposite pivot point (1105) from said gripper arms (1010).

11. The pizza dough shaping device of claim 2, wherein a mass of each of said counterweights (1015) multiplied by a distance (1110) from said pivot point to a center of mass of said counterweight (1015) is greater than a mass of said gripper arm (1010) and said gripper (1005) multiplied by a distance from said pivot point to said center of its mass.

12. The pizza dough shaping device of claim 2, wherein an outward rotation of said counterweights results in an inward rotation of said grippers.

13. The pizza dough shaping device of claim 1, wherein a weight of each of a plurality of counterweights is between about 5 pounds to about 12 pounds.

14. The pizza dough shaping device of claim 1, wherein a weight of each of a plurality of counterweights is about 8 pounds.

15. A method for pizza dough shaping comprising:
placing a dough ball roughly centered on a pan (1305);
placing said pan onto a turntable (1310);
initiating a start (1315);
engaging and centering gripping clamps of a clamping system (220) on said pan on said turntable (1320);
lowering a forming ring, surrounding said dough ball (1325);
lowering said ram, pressing said dough ball into a pancake that is accurately round and of uniform thickness (1330);
readying to spin (1335);
spinning ramp-up (1340);
sustaining spin (1345); and
ramping down (1350) through preselected profiles for uniform results, whereby said dough ball is formed into a finished pizza crust disk in approximately 30 seconds.

16. The pizza dough shaping method of claim 15, wherein said step of engaging and centering (1320) comprises:
an inward force of said gripping clamps against said pan, said inward force comprising a spring force.

17. The pizza dough shaping method of claim 15, wherein said step of spinning ramp-up (1340) comprises:
an inward-rotation of counterweights, whereby said gripping clamps are forced against said pan, aligning said pan concentrically to a rotation axis of said pan.

18. The pizza dough shaping method of claim 15, wherein said step of ramping down (1350) comprises:
an outward-rotation of counterweights, whereby a force of said gripping clamps against said pan is decreased.

19. The pizza dough shaping method of claim 15, wherein as said rotor (1025) rotates faster, a grip on pan (1030) increases in proportion to a rotation speed; and
a gripping force on said pan (1030) is an initial spring force plus a centrifugal effect force.

20. A system for pizza dough shaping comprising:
a main housing (205);
a main drive (210);
a turntable (215) holding a pan for rotation;
a clamping system (220) positioning said pan concentrically on turntable (215) and holding it securely during spinning;
a forming ring (225) working with a ram (230); and
a ram drive (235);
wherein said device operation steps comprise:
placing a dough ball roughly centered on said pan (1305);
placing said pan onto said turntable (1310);
initiating start (1315);
clamps of said clamping system (220) engaging and centering said pan on said turntable (1320);
said forming ring lowering and surrounding said dough ball (1325);
said ram lowering and pressing said dough ball into a pancake that is substantially round and of uniform thickness (1330); readying to spin (1335); spinning ramp-up (1340); sustaining spinning at between about 200 and about 300 rpm (1345); and ramping down (1350) through preselected profiles for uniform results, whereby said dough ball is formed into a finished pizza crust disk in approximately 30 seconds.
